(19) United States
(12) Patent Application Publication
(10) Pub. No.: US 2001/0026578 A1
(43) Pub. Date: Oct. 4, 2001

(54) Code division multiple access transmitter and receiver

(76) Inventor: Takeshi Ando, Tokyo (JP)

Correspondence Address: SUGHRUE, MION, ZINN, MACPEAK & SEAS, PLLC, 2100 Pennsylvania Avenue, NW, Washington, DC, 20037-3213, US

(21) Appl. No.: 09/874,227

(22) Filed: Jun. 6, 2001

Related U.S. Application Data
(63) Continuation of application No. 09/131,884, filed on Aug. 10, 1998.
Application No. 09/131,884 is a continuation-in-part of application No. 08/572,018, filed on Dec. 14, 1995, now abandoned.

(30) Foreign Application Priority Data
Dec. 19, 1994 (JP) 334413/1994

(51) Int. Cl. H04B 1/69

(52) U.S. Cl. 375/130; 375/229

(57) ABSTRACT

A CDMA transmitter and receiver has a transmission assembly including a serial-to-parallel converter for converting transmission data into a modulation input wave composed of real and imaginary parts of a complex number, a pseudo random noise (PN) generator for generating real and imaginary parts of a complex spread spectrum code in which real and imaginary parts are uncorrelated and random, a spread spectrum modulator for effecting modulation on the transmission data by producing complex numbers of the modulation input wave from the serial-to-parallel converter and the complex spread spectrum code from the PN generator, a vector combiner for combining real and imaginary part signals outputted from the spread spectrum modulator, a transmit filter for limiting a band of an output signal from the vector combiner. The CDMA transmitter and receiver have a reception assembly including a receive filter for limiting a band of a received signal from the transmission assembly, a fractionally tap spacing equalizer for sampling the received signal at a rate which is an integral multiple of a chip rate thereof, and a waveform equalizer comprising a tranveral digital filter which uses a recursive least square adaptive algorithm for updating filter coefficients.

This is a Continuation-in-Part of application Ser. No. 08/572,018 filed Dec. 14, 1995.

### BACKGROUND OF THE INVENTION

1. Field or the Invention

The present invention relates to a code division multiple access (CDMA) transmitter and receiver, and more particularly to a method of and an apparatus for removing intersymbol interferences between CDMA transmitters and receivers for use in cellular digital mobile communications or the like.

2. Description of the Related Art:

Cellular digital mobile communications are required to accommodate as many users as possible in limited frequency resources. A CDMA process is an access process for meeting such a requirement. Other access processes include a frequency division multiple access (FDMA) process in which one of the radio channels in a plurality of frequency bands is specified at the time of a communication request, and a time division multiple access (TDMA) process in which radio channels are divided into periodic time slots and one of the radio channels is specified at the time of a communication request. According to the FDMA and TDMA processes, the specified radio channel or time slot is temporarily occupied by a certain user during communications. Unlike these FDMA and TDMA processes, the CDMA process allows a number of users to share one wide-band radio channel by using mutually orthogonal spread-spectrum codes (SS codes).

In a spread spectrum modulation, transmitting data is modulated in a wide frequency band by multiplying by a spread spectrum code having higher frequency than the transmitting data. The spread spectrum code is a signal in which every code is spread at random and uncorrelatedly with each other in wide band. The transmission data are composed of two bits modulated into one symbol of complex base band signal, composed of a sine component and a cosine component in a digital phase modulation.

Multiplication of complex numbers is shown as follows:

(I₁+jQ₁)*(R₁+jC₁)=(R₁*I₁−C₁*Q₁)+j(R₁*Q₁+I₁*C₁)

where I₁, Q₁ are the real part and the imaginary part of the transmission data, and R₁, C₁ are the real part and the imaginary part of the spread spectrum code series.

Similarly, in the case of a signal to be multiplexed, multiplication of complex numbers is shown as following:

(I₂+jQ₂)*(R₂+jC₂)=(R₂*I₂−C₂*Q₂)+j(R₂*Q₂+I₂*C₂)

where I₂, Q₂ are the real part and the imaginary part of the transmission data series, and R₁, C₁ are the real part and the imaginary part of the spread spectrum code series.

If R₁, C₁, R₂, and C₂ are uncorrelated with each other and random, then the combinations of the uncorrellated and random series of (R₁*I₁−C₁*Q₁), (R₁*Q₁+I₁*C₁), (R₂*I₂−C₂*Q₂), and (R₂*Q₂+I₂*C₂) are also expected to be uncorrellated and random.

By these operations, transmitting data are modulated in the spread spectrum code, and are mapped in a two dimensional signal space.

In order to, improve the frequency utilization efficiency of cellular digital mobile communications, it is necessary to remove interfering waves in a channel. For a cellular digital mobile communications system to use an interference canceler, it has to be able to receive randomaccess signals such as from access channels, user packets, etc. In addition, the cellular digital mobile communications system needs to handle multipath so as to avoid a reduction in the user capacity in multipath environments due to reflection from objects such as buildings in cities, for example.

In multipath environments, data transmission tends to suffer failures on account of various causes such as carrier phase shifts, timing phase shifts, carrier frequency shifts, timing frequency shifts, etc. Therefore, it is necessary to correct for such phase and frequency shifts. Known techniques for eliminating intersymbol interference distortions generated in multipath propagation paths are adaptive equalizing systems based on a combination of various adaptive algorithms for carrying out various processes including linear equalizing, decision feedback equalizing (DFE), maximum likelihood sequence estimating (MLSE), etc.

One specific conventional arrangement for removing intersymbol interferences and correcting for frequency shifts is a data transmission demodulator disclosed in Japanese laid-open patent publication No. 4-352523 (1992). FIG. 1 of the accompanying drawings shows the disclosed data transmission demodulator.

The disclosed data transmission demodulator is designed to remove both intersymbol interferences and phase variations even when a recursive least square (RLS) algorithm having a high convergence speed is used. As shown in FIG. 1, the disclosed data transmission demodulator comprises a front filter 102 for being supplied with data in the form of a complex-number representation of the detected output of an orthogonal amplitude modulated wave, a back filter 103 for being supplied with output data in the form of a complex-number representation of a decision result, an adder 101 for adding a feedback output to an output signal from the front filter 102, a decision unit 100 for being supplied with and deciding on an output signal from the adder 101, a tap coefficient controller 104 for updating tap coefficients of the two filters 102, 103 according to an RLS algorithm, with an error between input and output signals of the decision unit 100, the past detected output, and an output signal from the decision unit 100, a phase controller 105, a complex conjugate unit 106, and multipliers 107, 108.

The data transmission demodulator operates as follows: The phase controller 105 detects a phase variation from an error E between input and output signals of the decision unit 100. Depending on the detected phase variation, the phase controller 105 imparts a phase rotation exp(−j %) to an output signal Yk indicative of the sum of the output signals from the filters 102, 103 thereby to compensate for the phase variation, and the complex conjugate unit 106 imparts a phase variation, exp(jø) through the multiplexers 108, 107 to the back filter 103 and the error E which is inputted to the tape coefficient controller 104.

The conventional data transmission demodulator can remove intersymbol interferences and correct for frequency shifts. However, for the purpose of imparting the phase rotations, the conventional data transmission demodulator needs a number of components including the multiplier 108, the front filter 102, the back filter 103, the phase controller 105, the complex conjugate unit 106, and the multiplier 107. Consequently, the conventional data transmission demodulator has a complex circuit arrangement and is large in size.

### SUMMARY OF THE INVENTION

It is therefore an object of the present invention to provide a method of and an apparatus for removing intersymbol interferences and correcting for frequency shifts between CDMA transmitters and receivers through a relatively simple arrangement.

To achieve the above object, there is provided in accordance with the present invention a method of transmitting and receiving data through code division multiple access, comprising the steps of modulating transmission data with pseudorandom noise signal into a signal of a complex spread spectrum code in which real and imaginary parts of a complex-number representation are uncorrelated and random, and transmitting the modulated transmission data, receiving and sampling the modulated transmission data at a rate which is an integral multiple of, e.g., twice, a chip rate of spread code (chip rate) thereof by way of fractionally tap spacing equalization, and waveform-equalizing the sampled transmission data according to a recursive least square (RLS) adaptive algorithm thereby to demodulate the transmission data.

In the case of a CDMA system, the receiving characteristics depend very much on the accuracy of code synchronization (chip synchronization) in the de-spread period.

Sampling one chip, which is an information unit of a spread code, at twice the rate enables de-spreading at an accuracy of ½ interval. If the sampling rate is doubled once again, a chip can be sampled at a rate of 4 times rapidity, and so de-spreading is processed at an accuracy of ¼ chip intervals.

If the timing of a sampling clock is doubled by changing the rate of the sampling clock of a fractionally spaced equalizer, the number of register steps of the equalizer is also required to be doubled. This results in advantages, such that the characteristics of the receiving and the ability of removing the interference between codes are enhanced.

According to the present invention, there is also provided an apparatus for transmitting and receiving data through code division multiple access, comprising a transmission assembly comprising a serial-to-parallel converter for converting transmission data into a modulation input wave composed of real and imaginary parts of a complex number, a pseudorandom noise generator for generating real and imaginary parts of a complex spread spectrum code in which real and imaginary parts are uncorrelated and random, a spread spectrum modulator for effecting spread spectrum modulation on the transmission data by producing complex numbers of the modulation input wave from the serial-to-parallel converter and the complex spread spectrum code from the pseudorandum noise generator, a vector combiner for combining real and imaginary part signals outputted from the spread spectrum modulator, a transmit filter for limiting a band of an output signal from the vector combiner, and a reception assembly comprising a reception filter for limiting a band of a received signal from the transmission assembly, a fractionally tap spacing equalizer for sampling the received signal at a rate which is an integral multiple of a chip rate thereof, through fractionally tap spacing equalization, and a waveform equalizer comprising a transversal digital filter which uses a recursive least square (RLS) adaptive algorithm for updating filter coefficients.

With the above arrangement, the transmission assembly includes the serial-to-parallel converter, the pseudorandom noise generator, the spread spectrum modulator, the vector combiner and the transmit filter. When the transmission data composed of real and imaginary parts outputted from the serial-to-parallel converter is modulated by way of spread spectrum modulation by the spread spectrum modulator, the spread spectrum modulator employs a complex spread spectrum code in which real and imaginary parts are uncorrelated and random, generated by the pseudorandom noise generator. Real and imaginary part signals subjected to spread spectrum modulation are combined by the vector combiner, and an output signal from the vector combiner is limited in band by the root Nyquist transmit filter, from which the band-limited signal is transmitted.

The reception assembly includes the reception filter, the fractionally tap spacing equalizer, and the waveform equalizer. The transmitted signal from the transmission assembly is received and limited in band by the root Nyguist receive filter. The received signal is sampled at a which is an integral multiple of the chip rate thereof, through fractionally tap spacing equalization, and thereafter demodulated according to the recursive least square adaptive algorithm by the waveform equalizer.

The reception assembly performs the function of reverse-spreading and demodulation of the output signal. Conventionally, the most common method of reverse-spreading and demodulation is to provide at a receiving side a spreading code generation circuit which generates the same code series as of a sending side, and to demodulate a transmitted signal by correlating (reverse-spreading) between the generated code signal and the received signal. As for correlating, a matched filter configuration is adopted.

In the present invention, the spreading code generation circuit is omitted, and the correlating operation is executed by a transverse digital filter which tap coefficients are sequentially renewed by training. This filter circuit can be used as a conventional matched filter by inputting the spread code as the tap coefficients.

The sampling signal, at a rate of integral multiple of a diffusion rate by a fractional spaced equalizer, is the complex base band signal, and the signal is reverse-spreaded by complex-multiply calculation by the tap coefficients (each of which composed of a real part and an imaginary part) at the tap coefficient port of the digital transverse type filter, and by integrate calculation at the adder.

The above and other objects, features, and advantages of the present invention will become apparent from the following description referring to the accompanying drawings which illustrate an example of the preferred embodiment of the present invention.

### BRIEF DESCRIPTION OF THE DRAWINGS

FIG. 1 is a block diagram of a conventional data transmission demodulator; and

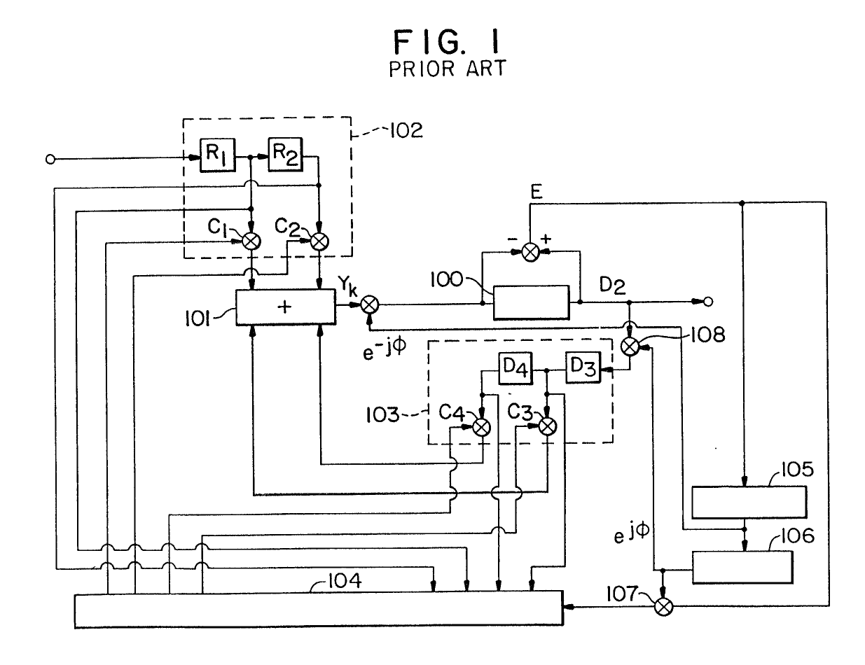

FIG. 2 is a block diagram of a CDMA transmitter and receiver according to the present invention.

FIG. 3 is a diagram showing the operation of the serial-to-parallel converter used in the present invention.

### DETAILED DESCRIPTION OF THE PREFERRED EMBODIMENTS

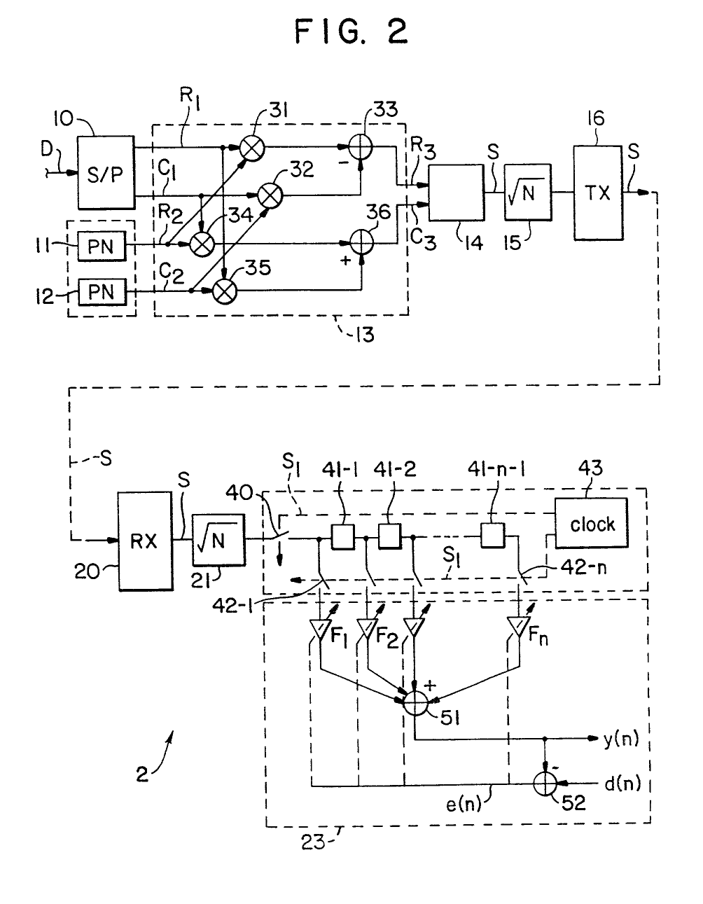

A CDMA transmitter and receiver according to the present invention will be described below with reference to FIG. 2.

As shown in FIG. 2, the CDMA transmitter and receiver has a transmission assembly 1 comprising a serial-to-parallel converter 10, a pair of pseudorandom noise (PN) signal generators 11, 12, a spread spectrum modulator 13, a vector combiner 14, a root Nyquist transmit filter 15, and a transmitter 16. The transmission assembly 1 effects spread spectrum modulation using a complex spread spectrum code in which real and imaginary parts of a complex-number representation are uncorrelated and random.

The serial-to-parallel converter 10 distributes digital transmission data D to each data period, and generates a real part (In-phase) R1 and an imaginary port (Quadrature-phase) C1 of a modulation input wave. The PN signal generators 11, 12 generate, respectively, a real part R2 and an imaginary part C2, which are uncorrelated and random, of a complex spread spectrum code.

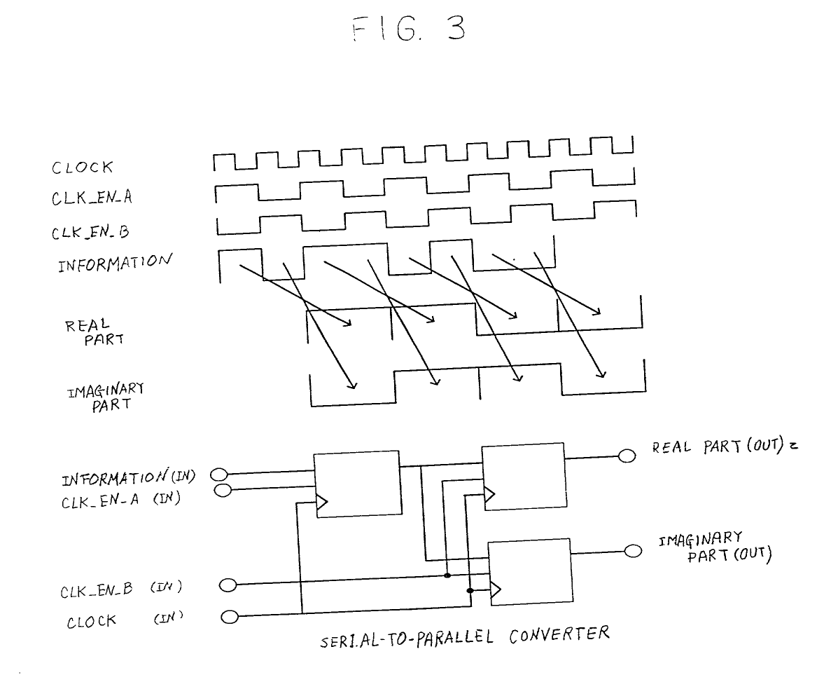

More particularly, the function of the serial-to-parallel converter 10 is illustrated in FIG. 3. The converter converts every symbol of an information data series to a real part (I) and an imaginary part (Q), and outputs both of them in parallel and simultaneously, as shon in FIG. 3. This operation causes a symbol period to double.

As the symbol period is doubled, the length of a diffusion code is doubled, and consequently, many more diffusion codes will be available. This has the advantage of increasing the number of multiple users and eliminating interference between codes over a wide range, in the multipath environment.

The spread spectrum modulator 13 is supplied with the real part R1 and the imaginary part C1 of the modulation input wave from the serial-to-parallel converter 10, and the real part R2 and the imaginary part C2 of the complex spread spectrum code from the PN signal generators 11, 12, and effects spread spectrum modulation by way of the product of the supplied complex numbers. More specifically, the spread spectrum modulator 13 has two multipliers 31, 32 and a subtracter 33 which are connected to the output terminals of the serial-to-parallel converter 10. The multiplier 31 multiplies the real part R1 the modulation input wave from the serial-to-parallel converter 10 and the real part R2 of the complex spread spectrum code from the PN signal generator 11. The multiplier 32 multiplies the imaginary part C1 of the modulation input wave from the serial-to-parallel converter 10 and the imaginary part C2 of the complex spread spectrum code from the PN signal generator 12.

The subtractor 33 subtracts an output signal of the multiplier 32 from an output signal of the multiplier 31, and outputs a rear part signal R3 representing the difference therebetween.

The spread spectrum modulator 13 also has two multipliers 34, 35 and an adder 36 which are connected to the output terminals of the PN signal generators 11, 12. The multiplier 34 multiplies the real part R2 of the complex spread spectrum code from the PN signal generator 11 and the imaginary part C1 of the modulation input wave from the serial-to-parallel converter 10. The multiplier 35 multiplies the imaginary part C2 of the complex spread spectrum code from the PN signal generator 11 and the imaginary part C1 of the modulation input wave from the serial-to-parallel converter 10. The adder 36 adds output signals from the multipliers 34, 35, and outputs an imaginary part signal C3 represents the sum thereof.

The vector combiner 14 combines the real part signal R3 from the subtractor 33 and the imaginary part signal C3 from the adder 36 to produce a combined modulated signal S. The transmit filter 15, indicated by √\overline{N}, is a so-called root Nyquist filter and limits the lower band of the combined modulated signal S from the vector combiner 14. The transmitter 16 transmits the band-limited combined modulated signal S as a radio wave.

The CDMA transmitter and receiver also has a reception assembly 2 comprising a receiver 20, a root Nyquist receive filter 21, a fractionally tap spacing equalizer 22, and a waveform equalizer 22 which uses a complex number RLS adaptive algorithm. The reception assembly 2 modulates the transmission data D that is received.

The receiver 20 receives the modulated signal S transmitted from the transmission assembly 1, and outputs the received modulated signal S to the reception filter 21. The receive filter 21 limits the band of the received signal S.

The fractionally tap spacing equalizer 22 is a sampling circuit for effecting fractionally tap spacing equalization, and can sample the received signal S at a rate which is an integral multiple of the chip rate of the received signal S, e.g., twice the chip rate. Specifically, the fractionally tap spacing equalizer 22 comprises a plurality of delay elements 41-1-41-n connected in series with each other to a sampling unit 40, a plurality of switches 42-1-42-n, and a clock unit 43. The clock unit 43 outputs a clock signal Si which is applied to operate the sampling unit 40 at a rate which is an integral multiple of the chip rate of the received signal S. The clock signal Si is also applied to the switches 42-1-42-n to operate them in synchronism with the sampling unit 40.

The waveform equalizer 23 is a transversal digital filter which uses an RLS adaptive algorithm for updating filter coefficients. The waveform equalizer 23 has a plurality of tap coefficient units F1-Fn having respective input terminals connected respectively to the switches 42-1-42-n of the fractionally tap spacing equalizer 22. The tap coefficient units F1-Fn also have respective output terminals connected to an adder 51 which adds output signals from the tap coefficient units F1-Fn. The adder 51 has an output terminal connected to a subtractor 52 which determines the difference between a desired signal d(n) and an output signal from the adder 51 which represents the sum of the output signals from the tap coefficient units F1-Fn. The subtractor 52 feeds a differential signal e(n) back to the tap coefficient units F1-Fn. The tap coefficient units F1-Fn are capable of controlling their output signals so as to eliminate the differential signal e(n).

Operation of the CDMA transmitter and receiver shown in FIG. 2 will be described below.

When the transmission assembly 1 operates to transmit transmission data D, the serial-to-parallel converter 10 distributes digital transmission data D to each data period, and outputs a real part R1 and an imaginary part C1 of its modulation input wave to the spread spectrum modulator 13. Concurrent with this, the PN signal generates 11, 12 generate and output a real part R2 and an imaginary part C2 of a complex spread spectrum code to the spread spectrum modulator 13.

In the spread spectrum modulator 13, the multiplier 31 multiplies the real part R1 of the modulation input wave and the real part R2 of the complex spread spectrum code, and the multiplier 32 multiplies the imaginary part C1 of the modulation input wave and the imaginary part C2 of the s complex spread spectrum code. Thereafter, the subtractor 33 subtracts an output signal of the multiplier 32 from an output signal of the multiplier 31, and outputs the difference as a real part signal R3.

At the same time, the multiplier 34 multiplies the real part R2 of the complex spread spectrum code and the imaginary part C1 of the modulation input wave, and the multiplier 35 multiplies the imaginary part C2 of the complex spread spectrum code and the real part R1 the modulation input wave. Thereafter, the adder 36 adds output signals from the multipliers 34, 35, and outputs the sum as an imaginary part signal C3.

When the spread spectrum modulator 13 outputs the real part signal R3 and the imaginary part signal C3, the vector combiner 14 combines the real part signal R3 and the imaginary part signal C3 with each other into a combined modulated signal S. The combined modulated signal S is limited in band by the transmit filter 15, and the band-limited modulated signal S is then transmitted from the transmitter 16 toward the reception assembly 2.

In the reception assembly 2, the modulated signal S is received by the receiver 20, and then limited in band by the receive filter 21. The band-limited modulated signal S is then supplied to the fractionally tap spacing equalizer 22. In the fractionally tap spacing equalizer 22, the modulated signal S is sampled by the sampling unit 40 at a rate which is an integral multiple of the chip rate of the received signal S. Sampled signals are stored in the respective delay elements 41-1-41-n, and also supplied through the switches 42-1-42-n respectively to the tap coefficient units F1-Fn of the waveform equalizer 23.

The waveform equalizer 23 demodulates the received signal S using an RLS adaptive algorithm for updating filter coefficients. Specifically, the adder 51 adds output signals from the tap coefficient units F1-Fn, and the subtractor 52 subtracts a desired signal d(n) from an output signal y(n) from the adder 51. The subtractor 52 feeds a differential signal e(n), which represents the difference between the desired signal d(n) and the output signal y(n), back to the tap coefficient units F1-Fn. The signals supplied from the switches 42-1-42-n respectively to the tap coefficient units F1-Fn are controlled in order to eliminate the differential signal e(n). The output signals produced from the tap coefficient units F1-Fn produced as a result of such a feedback control process are added by the adder 51, which outputs the output signal y(n) as an output signal from the waveform equalizer 23.

If the transmission data frame includes a pilot symbol, which is a data series at the predetermined symbol position in the transmission data frame and settled by both of the sending side and the receiving side, the pilot symbol is adopted as a desired signal d(n), then the filter coefficients are trained to minimize the difference between d(n) and the received signal. If the transmission data frame does not include the pilot symbol, the filter coefficients can be trained by inputting a feedback signal of the demodulated signal as the desired signal d(n).

According to the present invention, as described above, the transmission assembly 1 effects spread spectrum modulation by way of the product of complex numbers using a complex spread spectrum code in which real and imaginary parts of a complex-number representation are uncorrelated and random. Therefore, the period of symbols is twice and the length of the spread spectrum code is also twice as compared with data modulation based on a binary phase shift keying (BPSK) process. As a consequence, since the number of types of spread spectrum codes can be increased, it is possible to increase the number of multiple users, and multipath intersymbol interferences can be eliminated over a wider range.

Alternatively, instead of the Q-phase shift keying (QPSK) system used at the transmitter side, discussed above, the modulation can be by an Offset QPSK modulation system.

Adoption of an Offset QPSK modulation system proceeds a simple transmitter amplifier, and the receiving characteristics are heightened against the increasing receiver noise.

An Offset QPSK modulation system is realized by shifting one of either the real part “I” or the imaginary part “Q” of complex diffusion code, at a half time of tip rate, and then execute diffusion modulation again by using the onepart-shifted complex diffusion code.

The construction of the receiver need not be changed because the received data is sampled at an integer number rate of tip rate by a fractional tap spaced equalizer, even when the modulation system of the transmitter is changed to the Offset QPSK system. The reception assembly 2 includes the waveform equalizer 23 which employs a complex-number RLS adaptive algorithm. Consequently, it is not necessary for the reception assembly 2 to have independent modulators respectively for In-phase and Quadrature-phase parts. This makes it possible to simplify the reception assembly 2, and reduce the size of the entire CDMA transmitter and receiver.

The present invention uses a RLS algorithm for renewing algorithm of the tap coefficients. RLS algorithm is superior for adopting such an environment requiring very quick convergence as in a mobile communication system wherein the variation in the transmission route is not negligible to the symbol speed.

Furthermore, since the reception assembly 2 also has the fractionally tap spacing equalizer 22, it is possible to absorb timing jitter for an increased capability to remove intersymbol interferences.

It is to be understood that variations and modifications of the method of and the apparatus for removing intersymbol interferences between CDMA transmitters and receivers disclosed herein will be evident to those skilled in the art. It is intended that all such modifications and variations be included within the scope of the appended claims.

What is claimed is:

1. A method of transmitting and receiving data through code division multiple access, comprising the steps of:
modulating transmission data, converted into a first real part and a first imaginary part by a serial-to-parallel converter, with a pseudorandom noise signal having a second real part and a second imaginary part into a modulated output signal having a complex-number representation of a complex spread spectrum code in which real and imaginary parts of said complex-number representation are uncorrelated and random, and transmitting said modulated output signal;
receiving and sampling said modulated output signal at a rate which is an integral multiple of a chip rate thereof by way of fractionally tap spacing equalization; and
waveform-equalizing the sampled transmission data according to a recursive least square adaptive algorithm thereby to demodulate the transmission data.

2. A method according to claim 1, wherein the modulated transmission data is sampled at a rate which is twice the chip rate thereof by way of fractionally tap spacing equalization.

3. An apparatus for transmitting and receiving data through code division multiple access, comprising:
a transmission assembly comprising:
a serial-to-parallel converter for converting transmission data into a modulation input wave composed of a first real part and a first imaginary part of a complex number;
a pseudorandom noise generator for generating a second real part and a second imaginary part of a complex spread spectrum code in which real and imaginary parts are uncorrelated and random;
a spread spectrum modulator for effecting spread spectrum modulation on said modulation input wave by producing a complex number having a third real part signal and a third imaginary part signal from said modulation input wave, having said first real part and said first imaginary part, from said serial-to-parallel converter and the complex spread spectrum code, having said second real part and said second imaginary part, from said pseudorandom noise generator;
a vector combiner for combining said third real part signal and said third imaginary part signal outputted from said spread spectrum modulator and providing a vector combiner output signal;
a transmit filter for limiting a band of said output signal from said vector combiner; and
a reception assembly comprising:
a reception filter for limiting a band of a received signal from said transmission assembly;
a fractionally tap spacing equalizer, having a plurality of switches, for sampling the received signal at a rate which is an integral multiple of a chip rate thereof, through fractionally tap spacing equalization; and
a waveform equalizer comprising a transversal digital filter which uses a recursive least square adaptive algorithm for updating filter coefficients and which has a plurality of tap coefficient units having respective input terminals connected to respectively to a switch of said plurality of switches of said fractionally tap spacing equalizer.

4. The apparatus for transmitting and receiving data through code division multiple access of claim 3 wherein said spread spectrum modulator produces said third real part signal of said complex number by multiplying said first real part by said second real part to produce a first intermediate part, multiplying said first imaginary part by said second imaginary part to produce a second intermediate part, then subtracting said second intermediate part from said first intermediate part.

5. The apparatus for transmitting and receiving data through code division multiple access of claim 4 wherein said spread spectrum modulator produces said third imaginary part signal of said complex number by multiplying said first real part by said second imaginary part to produce a third intermediate part, multiplying said first imaginary part by said second real part to produce a fourth intermediate part, then adding said third intermediate part and said fourth intermediate part.

6. The method according to claim 1, wherein a real part of said modulated output signal having a complex-number representation is produced by multiplying said first real part by said second real part to form a first intermediate part, multiplying said first imaginary part by said second imaginary part to form a second intermediate part, then subtracting said second intermediate part from said first intermediate part.

7. The method according to claim 6, wherein an imaginary part of said modulated output signal having a complex-number representation is produced by multiplying said first real part by said second imaginary part to form a second intermediate part, multiplying said first imaginary part by said second real part to form a fourth intermediate part, then adding said third intermediate part to said fourth intermediate part.

8. A method of data transfer in a code division multiple access communication system, comprising the steps of:
receiving a signal from a transmitter by way of said receiver, said signal being a modulated signal, then;
band-limiting said signal using a filter, thereby producing a band-limited modulated signal, then;
sampling said signal at a sampling rate which is an integral multiple of a chip rate thereof, using a fractional tap spacing equalizer to thereby produce sampled transmission data, then;
demodulating said signal according to a complex-number recursive least square adaptive algorithm, using a waveform-equalizer, thereby producing demodulated received transmission data without the need for independent demodulators for in-phase and quadrature-phase signal portions.

9. A method according to claim 8, wherein said sampling rate is twice said chip rate.

10. A method according to claim 8, prior to the said step of receiving, further comprising the steps of:
modulating transmission data, said transmission data converted into a first real part and a first imaginary part by a serial-to-parallel converter, with a pseudorandom noise signal having a second real part and a second imaginary part into a modulated output signal having a complex-number representation of a complex spread spectrum code in which real and imaginary parts of said complex-number representation are uncorrelated and random; and transmitting said modulated output signal to be received as said signal from said transmitter.

11. The method according to claim 10, wherein a real part of said modulated output signal having a complex-number representation is produced by multiplying said first real part by said second real part to form a first intermediate part, multiplying said first imaginary part by said second imaginary part to form a second intermediate part, then subtracting said second intermediate part from said first intermediate part.

12. The method according to claim 11, wherein an imaginary part of said modulated output signal having a complex-number representation is produced by multiplying said first real part by said second imaginary part to form a second intermediate part, multiplying said first imaginary part by said second real part to form a fourth intermediate part, then adding said third intermediate part to said fourth intermediate part.

13. An apparatus for communicating data using code division multiple access, comprising:
a reception assembly comprising:
a reception filter for band-limiting a received signal from said transmitter assembly, said received signal being a modulated signal;
a fractionally tap spacing equalizer connected to said reception filter and using fractionally tap spacing equalization to sample said received signal at a rate which is an integral multiple of a chip rate, to thereby produce sampled transmission data; and
a waveform equalizer connected to said fractionally tap spacing equalizer and comprising a transversal digital filter which demodulates said received signal according to a complex-number recursive least square adaptive algorithm for updating filter coefficients, whereby said reception assembly produces demodulated received transmission data without the need for independent demodulators for in-phase and quadrature-phase signal portions.

14. The apparatus of claim 13, wherein said fractionally tap spacing equalizer includes a plurality of switches and said waveform equalizer has a plurality of tap coefficient units having respective input terminals connected respectively to a switch of said plurality of switches of said fractionally tap spacing equalizer.

15. The apparatus of claim 13, further comprising:
a transmission assembly comprising:
a serial-to-parallel converter for converting information data for transmission, into a modulation input wave composed of a first real part and a first imaginary part of a complex number;
a pseudorandom noise generator for generating a second real part and a second imaginary part of a complex spread spectrum code in which real and imaginary parts are uncorrelated and random;
a spread spectrum modulator for effecting spread spectrum modulation on said information data by producing complex numbers using the modulation input wave from said serial-to-parallel converter and the complex spread spectrum code from said pseudorandom noise generator;
a vector combiner for combining real and imaginary part signals outputted from said spread spectrum modulator; and
a transmit filter for limiting a band of an output signal from said vector combiner.

16. The apparatus of claim 15, wherein said spread spectrum modulator further comprises:
a first multiplier connected to a real part output of said serial-to-parallel converter and a real part output of said pseudorandom noise generator;
a second multiplier connected to an imaginary part output of said serial-to-parallel converter and an imaginary part output of said pseudorandom noise generator;
a subtractor connected to an output said first multiplier and an output of said second multiplier for subtracting an output signal of said second multiplier from an output signal of said first multiplier and outputting said real part signals representing the difference therebetween;
a third multiplier connected to said imaginary part output of said serial-to-parallel converter and said real part output of said pseudorandom noise generator;
a fourth multiplier connected to said real part output of said serial-to-parallel converter and said imaginary part output of said pseudorandom noise generator; and
an adder connected to an output of said third multiplier and an output of said fourth multiplier for adding an output signal of said third multiplier to an output signal of said fourth multiplier and outputting said imaginary part signals representing the sum thereof.
